(19) United States
(12) Patent Application Publication
(10) Pub. No.: US 2014/0325496 A1
(43) Pub. Date: Oct. 30, 2014

(54) APPARATUS AND METHOD FOR FIRMWARE UPGRADE USING USB

(71) Applicant: CORE LOGIC INC., Seoul (KR)

(72) Inventor: GYOHUN SON, Gunpo-si (KR)

(73) Assignee: CORE LOGIC INC., Seoul (KR)

(21) Appl. No.: 14/259,402

(22) Filed: Apr. 23, 2014

(30) Foreign Application Priority Data
Apr. 26, 2013 (KR) 10-2013-0046896

(51) Int. Cl. G06F 9/445; G06F 9/44

(52) U.S. Cl. CPC G06F 8/665; G06F 9/4401
USPC 717/168

(57) ABSTRACT

Disclosed herein is an apparatus and method for upgrading firmware using a universal serial bus (USB). In the method, after setting a flag 1 in a nonvolatile memory mounted on the device, a device is booted in a download mode to download and write firmware binary data in the nonvolatile memory. Then, the device is rebooted after setting a flag 2 in the nonvolatile memory, and booted in a general mode after setting a flag 3 in the nonvolatile memory. Then, USB communication between the device and the computer is checked to determine whether the device succeeds in upgrading the firmware. Thus, even a device with no external key can conveniently upgrade the firmware, and even if power is interrupted during download of a new version of firmware binary data, next booting can be safely performed in the download mode, thereby allowing upgrade of the firmware using the USB.

### CROSS-REFERENCE TO RELATED APPLICATION

This application claims priority to Korean Patent Application No. 10-2013-0046896 filed on 26 Apr. 2013, and all the benefits accruing therefrom under 35 U.S.C. §119, the contents of which is incorporated by reference in its entirety.

### BACKGROUND

1. Technical Field

The present invention relates to an apparatus and method for upgrading firmware using a universal serial bus (USB).

2. Description of the Related Art

Firmware generally refers to a medium that is an intermediate between software and hardware and interconnects the same. For example, various hardware components installed on a main board cannot operate by themselves even though power is turned on.

In addition, an application program requires a proper medium to access electronic devices to perform desired work, in which the proper medium is firmware. Such firmware operates hardware, buffers software, and delivers control content from the software to the hardware.

Since firmware is typically located in a computer and maintains data therein even after the computer is turned off, the firmware includes many routines needed upon turning-on the computer and many programs operating automatically. Firmware upgrading techniques have been mainly used for personal computers (PCs) or mobile terminals. For instance, some commercially available products among cards (e.g., sound cards, VGA cards, and modem cards) inserted into PCs, or commercially available mobile terminals have a function capable of upgrading firmware.

### BRIEF SUMMARY

It is an aspect of the present invention to provide an apparatus and method for upgrading firmware using a universal serial bus (USB), which allows convenient upgrade of the firmware using the USB even in a device without an external key.

It is another aspect of the present invention to provide an apparatus and method for upgrading firmware using a USB, which allows upgrade of the firmware using the USB by allowing subsequent booting to be safely performed in a downloading mode even if to power is interrupted during download of a new version of firmware binary data (i.e., data for upgrading the firmware).

It should be understood that the present invention is not limited to the foregoing aspects, and other aspects will become apparent to those skilled in the art from the following description.

In accordance with one aspect of the invention, a method of upgrading firmware using a universal serial bus (USB) includes: rebooting a device after setting a flag 1 in a nonvolatile memory mounted on the device; booting the device in a downloading mode for upgrading the firmware if the flag 1 is set, downloading firmware binary data from a computer to write the firmware binary data in the nonvolatile memory, setting a flag 2 in the nonvolatile memory, and rebooting the device; setting a flag 3 in the nonvolatile memory if the flag 2 is set, and booting up the device in a general mode; and determining whether the firmware is successfully upgraded, by checking USB communication between the device and the computer.

The method may further include: allowing the device to receive a firmware upgrade signal from the computer through a USB cable, wherein the setting the flag 1 is performed after receiving the firmware upgrade signal.

The operation of determining whether the firmware is successfully upgraded may include: determining that the firmware is successfully upgraded if the USB communication between the device and the computer succeeds; and determining that the firmware is not successfully upgraded if the USB communication between the device and the computer fails.

The method may further include: booting the device in the general mode after clearing the flags 1, 2 and 3, upon determining that the firmware is successfully upgraded.

The method may further include: booting the device in the download mode by setting the flag 1 and clearing the flags 2 and 3, upon determining that the firmware is not successfully upgraded and the flag 3 is set.

The operation of setting the flag 1 and clearing the flags 2 and 3 may be performed after the device is turned off and then turned on according to user manipulation.

The method may further include: booting the device in the download mode, if the flag 1 is set in the nonvolatile memory, when the device is turned off while proceeding with firmware upgrade.

The method may further include: booting the device in the general mode after setting the flag 3, if the flag 2 is set in the nonvolatile memory, when the device is turned off while proceeding with firmware upgrade.

The method may further include: booting the device in the download mode by setting the flag 1 and clearing the flags 2 and 3, if the flag 3 is set in the nonvolatile memory, when the device is turned off while proceeding with firmware upgrade.

In accordance with another aspect of the invention, an apparatus for upgrading firmware using a universal serial bus (USB) includes: a flag setting unit setting a plurality of flags in a nonvolatile memory mounted on a device; a boot mode selection unit checking setting stages of the flags and selecting one between a downloading mode for upgrading the firmware and a general mode as a boot mode of the device; and a boot mode execution unit writing firmware binary data in the nonvolatile memory by downloading the firmware binary data from a computer when the downloading mode is selected, and determining whether the firmware is successfully upgraded by checking USB communication between the device and the computer when the general mode is selected.

The flag setting unit may set at least one among three flags 1, 2 and 3 in the nonvolatile memory, and the boot mode selection unit may select the download mode as the booting mode of the device when the flag 1 is set, and select the general mode as the boot mode of the device when the flag 2 or 3 is set.

The flag setting unit may set the flag 1 after the device receives a firmware upgrade signal from the computer through a USB cable.

The boot mode execution unit may reboot the device after clearing the flags 1, 2 and 3, upon determining that the firmware is successfully upgraded.

The boot mode execution unit may reboot the device after setting the flag 1 and clearing the flags 2 and 3, upon determining that the firmware is not successfully upgraded and the flag 3 is set.

The boot mode execution unit may set the flag 1 and clear the flags 2 and 3 after the device is turned off and then turned on according to user manipulation.

The boot mode execution unit may boot the device in the download mode, if the flag 1 is set in the nonvolatile memory, when the device is turned off while proceeding with firmware upgrade.

The boot mode execution unit may boot the device in the general mode after setting the flag 3, if the flag 2 is set in the nonvolatile memory, when the device is turned off while proceeding with firmware upgrade.

The boot mode execution unit may boot the device in the download mode by setting the flag 1 and clearing the flags 2 and 3, if the flag 3 is set in the nonvolatile memory, when the device is turned off while proceeding with firmware upgrade.

The boot mode selection unit may check the setting states of the flags through a bootloader.

According to the present invention, the apparatus and method for upgrading firmware allow convenient upgrade of the firmware using a USB even in a device without an external key.

In addition, according to the present invention, the apparatus and method allow firmware upgrade using the USB by allowing next booting to be safely performed in a download mode even if power is interrupted during download of a new version of firmware binary data (i.e., data for upgrading the firmware).

### BRIEF DESCRIPTION OF THE DRAWINGS

The above and other aspects, features, and advantages of the invention will become apparent from the detailed description of the following embodiments in conjunction with the accompanying drawings, in which:

FIG. 1 is a conceptual diagram of an apparatus for upgrading firmware according to one embodiment of the present invention;

FIG. 2 shows one example of a bootloader proceeding with firmware upgrade by determining states of three flags according to one embodiment of the present invention;

FIG. 3 is a block diagram illustrating the apparatus for upgrading firmware using a USB according to one embodiment of the present invention; and

FIG. 4 is a flowchart of a method of upgrading firmware using a USB according to one embodiment of the present invention.

### DETAILED DESCRIPTION

Embodiments of the present invention will now be described in detail with reference to the accompanying drawings. It should be understood that the present invention is not limited to the following embodiments and may be embodied in different ways, and that the embodiments are given to provide complete disclosure of the present invention and to provide thorough understanding of the present invention to those skilled in the art. The scope of the present invention is limited only by the accompanying claims and equivalents thereof. Like components will be denoted by like reference numerals throughout the specification.

Generally, there are two methods for upgrading (or updating) firmware using a universal serial bus (USB) in the art.

One method refers to the case where a bootloader and a binary image for driving a device are separately stored in a read only memory (ROM). In this case, the device is booted by either USB download mode booting or normal mode booting selected in response to external key input.

In this case, however, the device requires an apparatus for receiving the external input in order to determine whether the device is booted through execution of a USB bootloader or normal mode booting.

The other method refers to the case that the bootloader is included in the binary image for driving the device. In this case, the binary image is loaded to a random access memory (RAM) in operation and the bootloader is invoked to upgrade the firmware in response to a firmware upgrade request.

However, in this case, if power is interrupted during download of a new version of a binary image in the device through a USB, the device cannot be booted again without a to particular method, for example, attachment of a joint test action group (JTAG) and the like.

Therefore, there has been proposed a booting method, in which a ROM having a capacity equal to two times or more the size of the binary image is prepared against power interruption during download of the binary image, and the downloaded image is alternately stored at both locations in a large storage space equal to two times or more the size of the binary image such that a normal binary image can be used even in the case that download fails. However, this method causes a waste of memory.

According to one embodiment of the present invention, a device can be safely booted in a bootloader mode even without an external key, thereby allowing upgrade of firmware using a USB.

In addition, according to one embodiment of the present invention, upgrade of the firmware using the USB is achieved by allowing next booting to be safely performed in a downloading mode even if power is interrupted during download of a new version of firmware binary data.

Next, embodiments of the present invention will be described in detail with reference to the accompanying drawings.

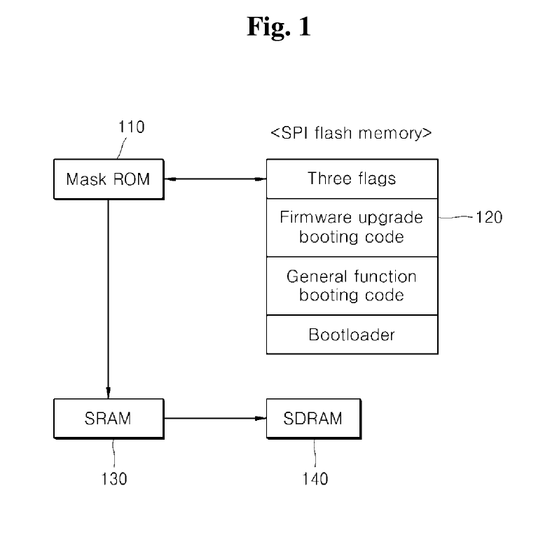

FIG. 1 is a conceptual diagram of an apparatus for upgrading firmware according to one embodiment of the present invention. Here, the apparatus for upgrading firmware may be mounted on a device.

For reference, the device may include any device that can read and operate driving software from a nonvolatile memory, such as a flash memory, a secure digital (SD) card, an electrically erasable programmable read only memory (EEPROM), and the like, and can upgrade the driving software through a USB interface.

Herein, the nonvolatile memory mounted on the device will be described as a serial peripheral interface (SPI) for convenience of understanding. However, it should be understood that the present invention is not limited thereto.

Referring to FIG. 1, when the device is turned on, a mask ROM 110 is first operated and serves to initialize an SPI flash memory 120 and deliver a bootloader stored in the SPI flash memory 120 to a static random access memory (SRAM) 130. Then, the mask ROM 110 allows a personal computer (PC) to move to the SRAM 130. The mask ROM 110 maintains data even though power is turned off, and allows only reading of the data.

The SPI flash memory 120 stores a bootloader, a firmware upgrade booting code for upgrading firmware, a general function booting code for general functions of the device, and three flags for storing firmware upgrade proceeding states. The SPI flash memory 120 maintains data even though power is turned off, and permits both reading and writing.

Here, the general function booting code refers to a code for booting up the device in a general mode, and the firmware upgrade booting code refers to a code for booting the device in a downloading mode.

The SRAM 130 is a place in which the bootloader operates. The bootloader determines a firmware upgrade proceeding state using three flags, and delivers either the firmware upgrade booting code or the general function booting code stored in the SPI flash memory to a synchronous dynamic random access memory (SDRAM 140) to execute the booting code. The SRAM 130 loses data when power is turned off.

Main code is loaded in the SDRAM 140. According to the states of the flags, one of the firmware upgrade booting code and the general function booting code is loaded in the SDRAM 140 and executed. The SDRAM 140 loses data when power is turned off.

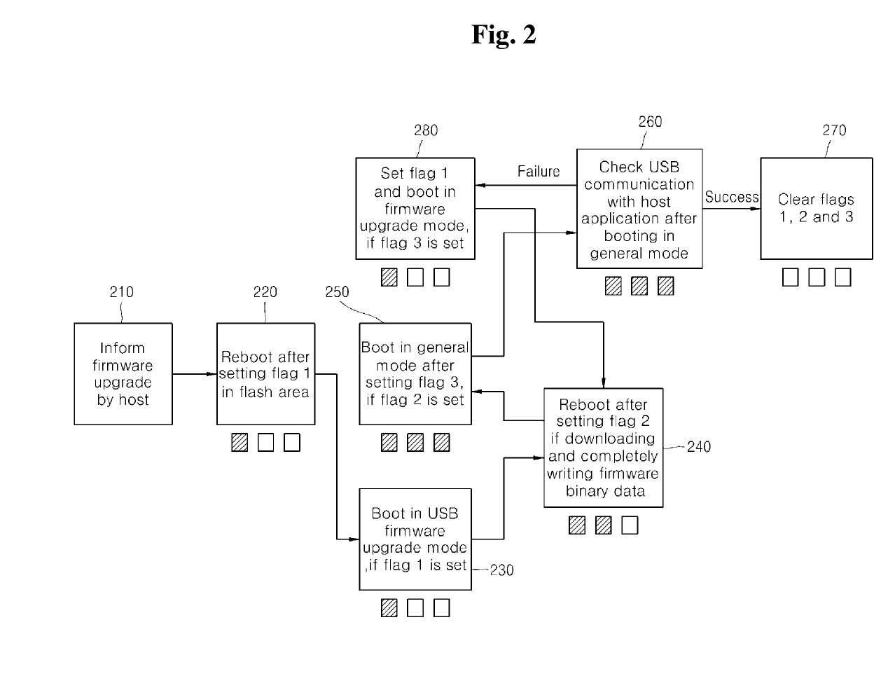

FIG. 2 shows one example of a bootloader proceeding with firmware upgrade by determining states of three flags according to one embodiment of the present invention.

Referring to FIGS. 1 and 2, the device according to the embodiment of the invention starts to boot from the mask ROM 110. The mask ROM 110 uses a code provided therein and delivers the bootloader stored in the SPI flash memory 120 to the SRAM 130. Thus, the PC jumps to the SRAM 130.

The bootloader loaded in the SRAM 130 determines the firmware upgrade proceeding state using the three flags stored in the SPI flash memory 120.

In an initial state, the three flags stored in the SPI flash memory 120 are all in a clear state, and thus, the bootloader delivers the general function booting code stored in the SPI flash memory 120 to the SDRAM 140. Then, the bootloader allows the PC to move to the SDRAM 140, thereby performing the general function booting code.

While the general function booting code is performed, a user may use a host application installed in the PC to upgrade the firmware. In this case, the host application sends a request signal for upgrading the firmware (i.e., a firmware upgrade signal) to the device (in 210), and thus the device is rebooted after setting a flag 1 stored in the SPI flash memory 120 (in 220).

Then, the device executes the bootloader and checks states of the three flags stored in the SPI flash memory 120. If the flag 1 is set, the bootloader delivers the firmware upgrade booting code stored in the SPI flash memory 120 to the SDRAM 140, and then allows the PC to move to the SDRAM 140 to boot the device in an upgrade mode (i.e., a download mode) (in 230).

Then, the bootloader writes a new version of firmware binary data, which is downloaded from the PC through the USB, on the SPI flash memory 120. Here, the bootloader overwrites the existing firmware binary data stored in the SPI flash memory 120 with the new version of firmware binary data. Then, the device is rebooted after setting the flag 1 (in 240).

Then, the device executes the bootloader and sets a flag 3 if the flag 2 is set. Further, the bootloader delivers the general function booting code stored in the SPI flash memory 120 to the SDRAM 140 to execute the general function booting code, thereby booting the device in the general mode (in 250). Thus, the bootloader executes the new version of firmware binary data, thereby upgrading the firmware.

Next, the device determines whether the firmware is successfully upgraded by checking USB communication with the host application (in 260). That is, the device determines that the firmware is successfully upgraded if the USB communication with the host application succeeds, and that the firmware is not successfully upgraded if USB communication with the host application fails.

When the firmware is successfully upgraded, the device clears the flags 1, 2 and 3 and returns to an ordinary state (in 270). However, when the firmware is not successfully upgraded, a user turns the device off and then on again.

When the device is turned on, the bootloader checks the state of the flag and sets the flag 1 if the flag 3 is set, and clears the flags 2 and 3 to perform booting of the device in the firmware upgrade mode (i.e., the downloading mode) (in 280).

On the other hand, if the device is turned off during download of the new version of firmware binary data from the PC, the flags are not all cleared since the device cannot perform USB communication with the host PC. In this case, a download state of the firmware may be maintained.

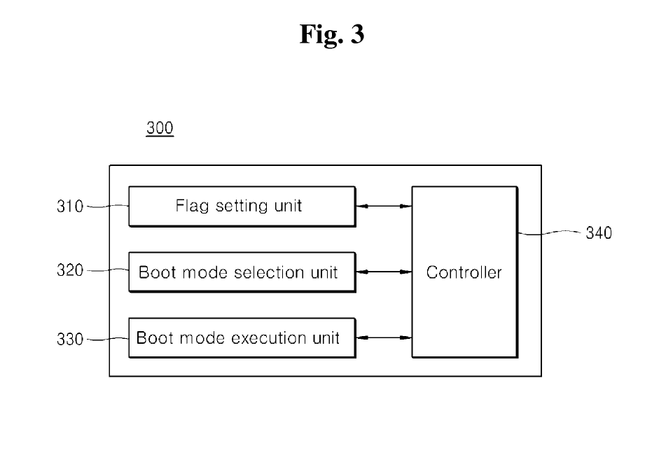

FIG. 3 is a block diagram illustrating an apparatus for upgrading firmware using a USB according to one embodiment of the present invention. Here, the apparatus for upgrading firmware may be mounted on a device targeted for firmware upgrade.

Referring to FIG. 3, an apparatus 300 for upgrading firmware using a USB according to one embodiment of the invention may include a flag setting unit 310, a boot mode selection unit 320, a boot mode execution unit 330, and a controller 340.

The flag setting unit 310 functions to set a plurality of flags in an SPI flash memory mounted in the device. In this embodiment, the flag setting unit 310 will be described to set three flags in the SPI flash memory.

After the device receives a firmware upgrade signal from a computer (PC) through a USB cable, the flag setting unit 310 first sets the flag 1 among the three flags 1, 2 and 3.

Further, the flag setting unit 310 sets the flag 2 after firmware binary data is completely downloaded and written. In addition, the flag setting unit 310 sets the flag 3 when the device is rebooted, with the flag 2 set.

The boot mode selection unit 320 checks the setting states of the flags and selects one between a downloading mode for upgrading the firmware and a general mode as a boot mode of the device. At this time, the boot mode selection unit 320 may check the setting states of the flags through the bootloader.

That is, the boot mode selection unit 320 may select the downloading mode as the boot mode of the device if the flag 1 is set. On the other hand, the boot mode selection unit 320 may select the general mode as the boot mode of the device if the flag 2 or 3 is set.

If the download mode is selected, the boot mode execution unit 330 downloads the firmware binary data from the computer into the SDRAM mounted on the device. Then, the boot mode execution unit 330 writes the downloaded firmware binary data in the SPI flash memory.

If the general mode is selected, the boot mode execution unit 330 checks USB communication between the device and the computer, and determines whether the firmware is successfully upgraded.

If it is determined that the firmware is successfully upgraded, the boot mode execution unit 330 clears the flags 1, 2 and 3 and reboots the device.

If it is determined that the firmware is not successfully upgraded, the boot mode execution unit 330 checks whether the flag 3 is set in the SPI flash memory through the bootloader. If the flag 3 is set in the SPI flash memory through the bootloader, the boot mode execution unit 330 sets the flag 1 when the device is turned off and then turned on again according to user manipulation, and clears the flags 2 and 3 to reboot the device.

The device can be turned off while proceeding with firmware upgrade. In this case, the boot mode execution unit 330 may boot the device in the downloading mode if the flag 1 is set in the SPI flash memory, and may boot the device in the general mode after setting the flag 3 if the flag 2 is set. In addition, if the flag 3 is set in the SPI flash memory, the boot mode execution unit 330 may set the flag 1 and clear the flags 2 and 3 to boot the device in the download mode.

The controller 340 controls the apparatus 300 for upgrading firmware using a USB, that is, general operations of the flag setting unit 310, the boot mode selection unit 320, and the boot mode execution unit 330.

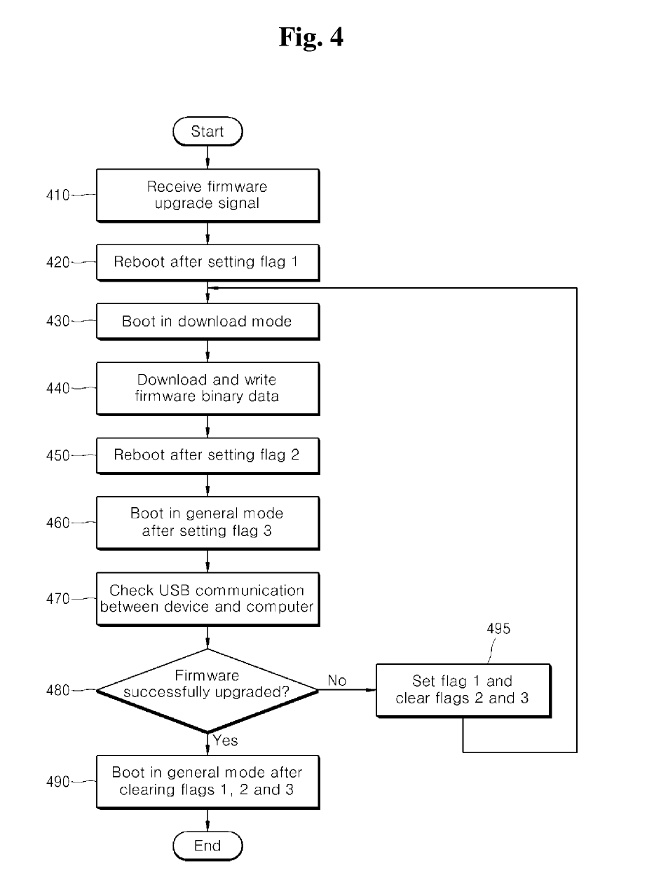

FIG. 4 is a flowchart of a method of upgrading firmware using a USB according to one embodiment of the present invention. Here, the method of upgrading firmware may be performed by the apparatus for upgrading firmware.

Referring to FIG. 4, in operation 410, the apparatus for upgrading firmware receives a firmware upgrade signal from a computer through a USB.

Next, in operation 420, the apparatus sets a flag 1 in a SPI flash memory mounted in the device and then reboots the device.

Next, in operation 430, the apparatus uses a bootloader to check that the flag 1 is set, and boots the device in a download mode for upgrading the firmware.

Next, in operation 440, the apparatus downloads firmware binary data from the computer, and writes the firmware binary data in the SPI flash memory.

Next, in operation 450, the apparatus sets a flag 2 in the SPI flash memory and reboots the device.

Next, in operation 460, the apparatus uses the bootloader to check that the flag 2 is set, and sets a flag 3 in the SPI flash memory to boot the device in a general mode.

Next, in operation 470, the apparatus checks USB communication between the device and the computer to determine whether the firmware is successfully upgraded.

If it is determined that the firmware is successfully upgraded (“Yes” in operation 480), the apparatus clears the flags 1, 2 and 3 and then boots the device in the general mode in operation 490.

If it is determined that the firmware is not successfully upgraded (“No” in operation 480), the apparatus uses the bootloader to check whether the flag 3 is set in the SPI flash memory, in operation 495. If the flag 3 is set in the SPI flash memory, the apparatus sets the flag 1 and clears the flags 2 and 3 to return to operation 430.

The embodiments of the present invention may be realized in the form of program instructions which can be implemented through various computer components, and may be recorded in a computer-readable storage medium. The computer-readable storage medium may include a program instruction, a local data file, a local data structure, and the like either alone or in combination thereof. The program instruction recorded in the computer-readable storage medium may be any program instruction particularly designed and structured for the present invention or known to those skilled in the field of computer software. Examples of the computer-readable storage medium include magnetic recording media such as hard disks, floppy disks and magnetic tapes, optical data storage media such as CD-ROMs or DVD-ROMs, magneto-optical media such as floptical disks, and hardware devices, such as a read-only memory (ROM), random-access memory (RAM) and flash memory, which are particularly structured to store and implement the program instruction. Examples of the program instruction include not only machine language code formatted by a compiler but also high level language code which can be executed by a computer using an interpreter.

Although some embodiments have been described herein, it should be understood by those skilled in the art that these embodiments are given by way of illustration only, and that various modifications, variations, and alterations can be made without departing from the spirit and scope of the invention. Therefore, the scope of the present invention should be limited only by the accompanying claims and equivalents thereof.

What is claimed is:

1. A method of upgrading firmware using a universal serial bus (USB), comprising:
rebooting a device after setting a flag 1 in a nonvolatile memory mounted on the device;
booting the device in a download mode for upgrading the firmware if the flag 1 is set, downloading firmware binary data from a computer to write the firmware binary data in the nonvolatile memory, setting a flag 2 in the nonvolatile memory, and rebooting the device;
setting a flag 3 in the nonvolatile memory if the flag 2 is set, and booting the device in a general mode; and
determining whether the firmware is successfully upgraded, by checking USB communication between the device and the computer.

2. The method according to claim 1, further comprising:
allowing the device to receive a firmware upgrade signal from the computer through a USB cable,
wherein the setting the flag 1 is performed after receiving the firmware upgrade signal.

3. The method according to claim 1, wherein the determining whether the firmware is successfully upgraded comprises:
determining that the firmware is successfully upgraded if the USB communication between the device and the computer succeeds; and
determining that the firmware is not successfully upgraded if the USB communication between the device and the computer fails.

4. The method according to claim 1, further comprising:
booting the device in the general mode after clearing the flags 1, 2 and 3, upon determining that the firmware is successfully upgraded.

5. The method according to claim 1, further comprising:
booting the device in the download mode by setting the flag 1 and clearing the flags 2 and 3, upon determining that the firmware is not successfully upgraded and the flag 3 is set.

6. The method according to claim 5, wherein the setting the flag 1 and clearing the flags 2 and 3 is performed after the device is turned off and then turned on according to user manipulation.

7. The method according to claim 1, further comprising:
booting the device in the download mode, if the flag 1 is set in the nonvolatile memory, when the device is turned off while proceeding with firmware upgrade.

8. The method according to claim 1, further comprising:
booting the device in the general mode after setting the flag 3, if the flag 2 is set in the nonvolatile memory, when the device is turned off while proceeding with firmware upgrade.

9. The method according to claim 1, further comprising:
booting the device in the download mode by setting the flag 1 and clearing the flags 2 and 3, if the flag 3 is set in the nonvolatile memory, when the device is turned off while proceeding with firmware upgrade.

10. An apparatus for upgrading firmware using a universal serial bus (USB), comprising:
a flag setting unit setting a plurality of flags in a nonvolatile memory mounted in a device;
a boot mode selection unit checking setting stages of the flags and selecting one between a download mode for upgrading the firmware and a general mode as a boot mode of the device; and
a boot mode execution unit writing firmware binary data in the nonvolatile memory by downloading the firmware binary data from a computer when the download mode is selected, and determining whether the firmware is successfully upgraded by checking USB communication between the device and the computer when the general mode is selected.

11. The apparatus according to claim 10, wherein the flag setting unit sets at least one among three flags 1, 2 and 3 in the nonvolatile memory, and the boot mode selection unit selects the download mode as the booting mode of the device when the flag 1 is set, and selects the general mode as the boot mode of the device when the flag 2 or 3 is set.

12. The apparatus according to claim 11, wherein the flag setting unit sets the flag 1 after the device receives a firmware upgrade signal from the computer through a USB cable.

13. The apparatus according to claim 11, wherein the boot mode execution unit reboots the device after clearing the flags 1, 2 and 3, upon determining that the firmware is successfully upgraded.

14. The apparatus according to claim 11, wherein the boot mode execution unit reboots the device after setting the flag 1 and clearing the flags 2 and 3, upon determining that the firmware is not successfully upgraded and the flag 3 is set.

15. The apparatus according to claim 14, wherein the boot mode execution unit sets the flag 1 and clears the flags 2 and 3 after the device is turned off and then turned on according to user manipulation.

16. The apparatus according to claim 11, wherein the boot mode execution unit boots the device in the download mode, if the flag 1 is set in the nonvolatile memory, when the device is turned off while proceeding with firmware upgrade.

17. The apparatus according to claim 11, wherein the boot mode execution unit boots the device in the general mode after setting the flag 3, if the flag 2 is set in the nonvolatile memory, when the device is turned off while proceeding with firmware upgrade

18. The apparatus according to claim 11, wherein the boot mode execution unit boots the device in the download mode by setting the flag 1 and clearing the flags 2 and 3, if the flag 3 is set in the nonvolatile memory, when the device is turned off while proceeding with firmware upgrade.

19. The apparatus according to claim 10, wherein the boot mode selection unit checks the setting states of the flags through a bootloader.
